(19) United States
(12) Patent Application Publication
(10) Pub. No.: US 2024/0369816 A1
(43) Pub. Date: Nov. 7, 2024

(54) OPTICAL PULSE GENERATOR AND METHOD

(71) Applicant: Cornell University, Ithaca, NY (US)

(72) Inventors: Chris XU, Ithaca, NY (US); Aaron Tsun Yin MOK, Ithaca, NY (US); Tianyu WANG, Ithaca, NY (US)

(21) Appl. No.: 18/656,563

(22) Filed: May 6, 2024

Related U.S. Application Data
(60) Provisional application No. 63/464,489, filed on May 5, 2023.

(51) Int. Cl. G02B 21/00; G02B 17/00; G02B 27/00; G02B 27/28

(52) U.S. Cl. CPC G02B 21/0032; G02B 17/004; G02B 21/0036; G02B 21/0076; G02B 27/0075; G02B 27/283

(57) ABSTRACT

An optical beamlet-array generator includes a ring resonator, a polarizing beamsplitter and a polarization optic. The ring resonator includes a plurality of mirrors that in part define a plurality of distinct optical paths within the ring resonator. The polarizing beamsplitter (i) is between a first mirror and a final mirror, (ii) outputs a first polarization component of an incident optical signal as a non-delayed output beamlet propagating along a non-delayed output-beam path, (iii) outputs a second polarization component of the incident optical signal onto a first optical path as a first delayed-beamlet propagating toward the first mirror. The beamsplitter reflects the transverse electric polarization component of the first delayed-beamlet out of the first optical path as a delayed-output beamlet that propagates along a delayed output-beam path that is offset from the non-delayed output-beam path. The polarization optic is on the first optical path and modifies the first delayed-beamlet's polarization state.

### CROSS-REFERENCE TO RELATED APPLICATIONS

This application claims the benefit of U.S. Provisional Application No. 63/464,489, filed on May 5, 2023, the disclosure of which is incorporated herein by reference in its entirety.

### GOVERNMENT RIGHTS

This invention was made with government support under Grant Number DBI-1707312 awarded by the National Science Foundation. The government has certain rights in the invention.

### BACKGROUND

High spatial and temporal resolution imaging over a large field-of-view (FOV) deep within intact tissues is valuable for many biological fields such as neuroscience, immunology, and cancer biology. While large FOV two-photon microscopy (2PM) has been successfully demonstrated in recording neural activities up to 5 mm FOV, the penetration depth of two-photon (2P) imaging is limited to 600 to 700 mm in the intact mouse brain, restricted to the shallow cortical layers. In contrast, three-photon microscopy (3PM) has been shown to reliably image neurons in deep cortical layers, subplates, and subcortex.

### SUMMARY OF THE EMBODIMENTS

Embodiments disclosed herein achieve imaging at deep penetration depths over a wide field of view. We have developed a Dual Excitation with adaptive Excitation Polygon-scanning multiphoton microscope (DEEPscope) that enables high-resolution imaging with a large FOV (3.5 mm diameter for example) deep in scattering tissue. High-resolution imaging is essential to minimize the risk of misattributing calcium transients by reducing the overlap between cells.

In a first aspect, optical beamlet-array generator includes a ring resonator, a polarizing beamsplitter and a polarization optic. The ring resonator includes a plurality of mirrors that at least in part define a plurality of distinct optical paths within the ring resonator. The polarizing beamsplitter (i) is between a first mirror and a final mirror of the plurality of mirrors, (ii) outputs a first polarization component of an incident optical signal as a non-delayed output beamlet propagating along a non-delayed output-beam path, (iii) outputs a second polarization component of the incident optical signal onto a first optical path of a plurality of distinct optical paths as a first delayed-beamlet propagating toward the first mirror. After the final mirror reflects the first delayed-beamlet, the beamsplitter reflects the transverse electric (TE) polarization component of the first delayed-beamlet out of the first optical path as a delayed-output beamlet that propagates along a delayed output-beam path that is laterally offset from the non-delayed output-beam path. The polarization optic is on the first optical path and modifies the first delayed-beamlet's polarization state.

In a second aspect, optical beamlet-array generator includes a ring resonator, an input-coupler, a polarizing beamsplitter and a polarization optic. The ring resonator includes a plurality of mirrors defining a plurality of distinct optical paths within the ring resonator. The input-coupler directs an incident optical signal to propagate, as a first delayed-beamlet, within the ring resonator along at least part of a first optical path of the plurality of distinct optical paths within the ring resonator. The polarizing beamsplitter (i) is between a first mirror and a final mirror of the plurality of mirrors, and (ii) reflects the transverse electric (TE) polarization component of the first delayed-beamlet as a delayed output beamlet propagating along a delayed output-beam path. The polarizing beamsplitter also (iii) transmits the transverse magnetic (TM) polarization component of the first delayed-beamlet onto a second optical path of the plurality of distinct optical paths as a second delayed-beamlet propagating toward the first mirror and (iv) after the final mirror reflects the second delayed-beamlet, reflects the transverse electric (TE) polarization component of the second delayed-beamlet out of the second optical path as an additional delayed-output beamlet that propagates along an additional delayed output-beam path that is laterally offset from the delayed output-beam path. The polarization optic is on the second optical path and modifies the second delayed-beamlet's polarization state.

In a third aspect, an optical beamlet-array generation method is disclosed. The method includes splitting an optical signal to yield a (i) first output beamlet having a first polarization state and propagating along a first output-beam path and (ii) a delayed-beamlet having a delayed polarization state, orthogonal to the first polarization state. The method also includes directing the delayed-beamlet around a ring resonator; and after said directing. The method also includes splitting the delayed-beamlet to yield a delayed-output beamlet that propagates along a delayed output-beam path that is laterally offset from the first output-beam path.

### BRIEF DESCRIPTION OF THE FIGURES

FIG. 1 is a schematic of a multiphoton microscope, in an embodiment.

FIG. 2 illustrates a comparison of the field-of-view (FOV) of an embodiment of the multiphoton microscope of FIG. 1 with conventional 3P microscopes.

FIG. 3 is a schematic of beamlet scanning with a beamlet generation delay line of an embodiment of the multiphoton microscope of FIG. 1.

FIG. 4 is a functional block diagram of an optical beam generator, in an embodiment.

FIGS. 5-10 are respective schematics of optical beamlet generators, each of which is an example of optical beamlet-array generator of the multiphoton microscope of FIG. 1.

FIG. 11 is a functional block diagram of an optical beam generator, in an embodiment.

FIG. 12 is a schematic of an optical beamlet generator, which is an example of optical beamlet generator of FIG. 11.

FIG. 13 is a block diagram of a cascaded optical beamlet-array generator.

FIG. 14 is a schematic of a cascaded optical beamlet-array generator, which is an example of the cascaded optical beamlet-array generator of FIG. 13.

FIG. 15 is a block diagram of microscope that includes the optical beamlet generator of either FIG. 4 or FIG. 11, in an embodiment.

FIG. 16 is a flowchart illustrating an optical beamlet-array generation method, which may be implemented by an optical beamlet generator of FIG. 4 or FIG. 11, in an embodiment.

### DETAILED DESCRIPTION OF THE EMBODIMENTS

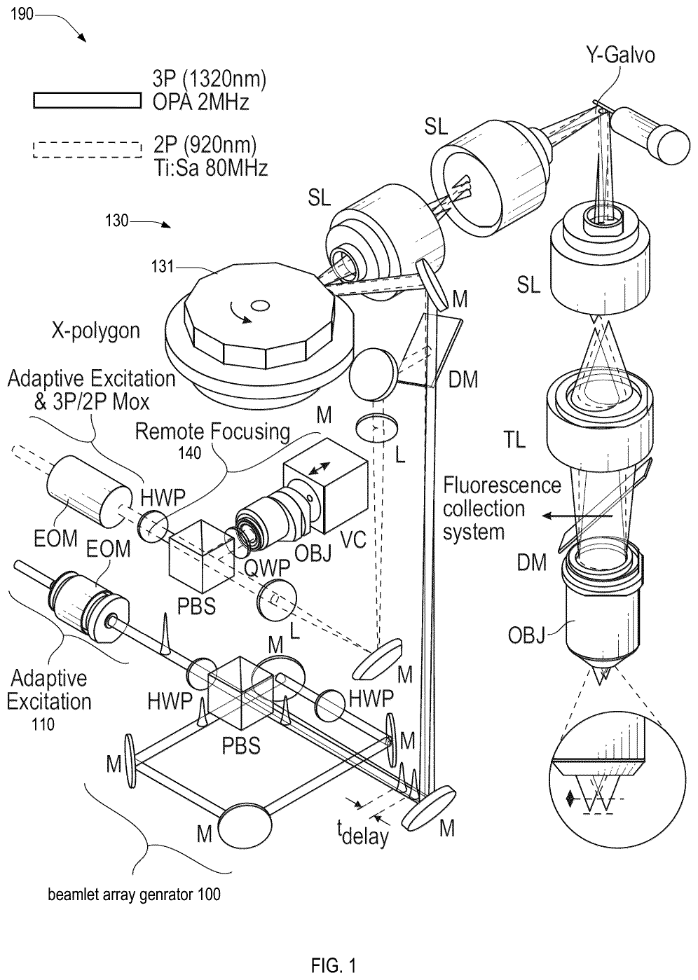

FIG. 1 is a schematic of a multiphoton microscope 190, hereinafter microscope 190. Microscope 190 allows simultaneous 2P and three-photon (3P) excitation (i.e., dual excitation). The 3P excitation path includes an adaptive excitation module 110, an optical beamlet-array generator 100, and a scan engine 130, which includes a polygon scanner 131. The 2P excitation path includes adaptive excitation module 110, a remote focusing module 140, and scan engine 130. Multiphoton microscope 190 also includes an electro-optic modulator (EOM), a half-wave plate (HWP), a quarter wave-plate (QWP), lenses L, mirrors M, a scan lens SL, a tube lens TL, dichroic mirror DM, and an objective lens OBJ.

Embodiments of multiphoton microscope 190 achieve deep and large FOV imaging in scattering brain tissues by (1) performing fast and large-angle optical scans using polygon scanner 131, (2) reducing the power required for large-FOV imaging using adaptive excitation, and (3) improving the excitation efficiency and scanning speed using optimized PSF and beamlets.

Compared to microscope 190, conventional polygon-scanning multiphoton microscopes have a relatively small FOV (˜582P×582P mm). We used polygon scanner 131 to achieve a large scan angle at high scanning speed, which also reduces the complexity of the scanning engine when compared to the existing large FOV microscopes. The optical path and the footprint for embodiments of multiphoton microscope 190 (˜3 ft×3 ft×1 ft) are nearly identical to a conventional multiphoton microscope. In embodiments, polygon scanner 131 has a larger aperture (9.5 mm) and more than twice the optical scan angle (˜60-degree peak-to-peak) than a resonant scanner. The polygon line rate (˜6 kHz) is >6 times that of galvo scanners (<1 kHz) at the same scan angle with ˜5 mm aperture size.

To optimize excitation efficiency and improve imaging speed using a low repetition rate laser, multiphoton microscope 190 implements a beamlet scanning scheme with a point spread function (PSF) optimized to the size of neurons. A higher excitation efficiency improves the detection fidelity of calcium transients (d′).

In a use scenario, we underfilled the back aperture of the multiphoton microscope 190's objective (˜85% filled). The axial resolution across the FOV was ˜5 mm full-width half maximum (FWHM). This size of the PSF is close to the optimum for the size of neuron cell bodies, and approximately doubled d′ value by increasing the fluorescence signal ˜4 times when compared to a PSF with 2-μm axial resolution.

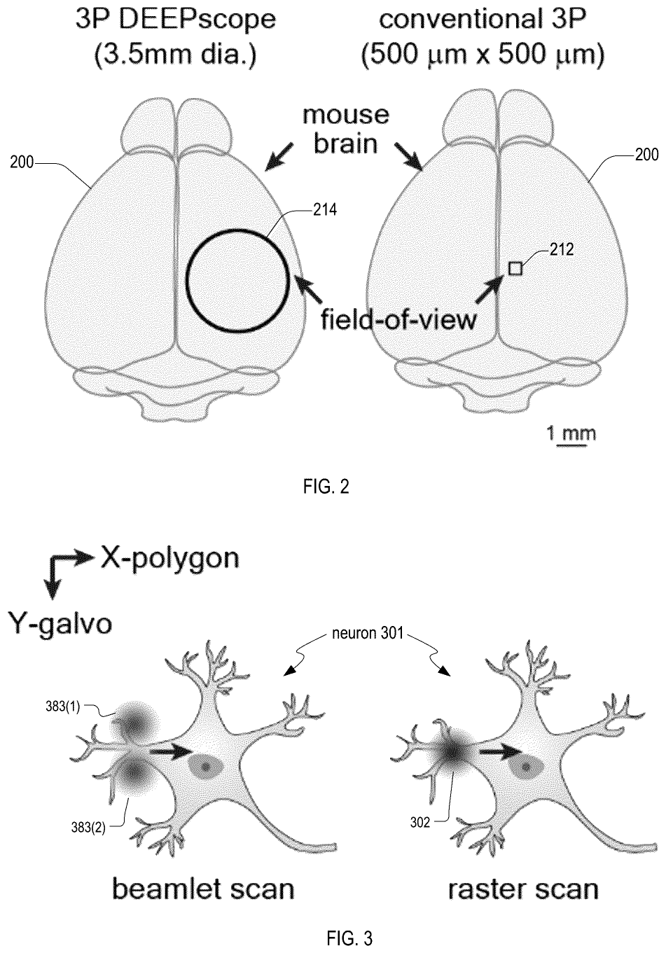

FIG. 2 illustrates a comparison of the field-of-view (FOV) of an embodiment of multiphoton microscope 190 with conventional 3P microscopes. In this use scenario, multiphoton microscope 190 images a 3.5-mm diameter FOV 214 in a mouse brain 200. FOV 214 is larger than a FOV 212 of a conventional three-photon microscope.

In addition, a beamlet scanning scheme is created in which two pulses were scanned in two adjacent lines with a time delay of ˜20 ns, as shown in FIG. 3. FIG. 3 is a schematic of beamlet scanning with optical beamlet-array generator 100 of an embodiment of multiphoton microscope 190. On the left side FIG. 3, a beamlets 383 (1) and 383 (2) scan a neuron 301 as part of a beamlet scan executed by multiphoton microscope 190. On the right side of FIG. 3, a single beam 302 scans neuron 301.

Compared to scanning with a PSF with 10-μm axial resolution, such a two-beamlet scanning scheme with two 5-μm axial resolution PSF further increased d′ value by ˜10% (fluorescence signal by ˜20%) using the same amount of total pulse energy at the focal plane. Furthermore, the beamlets doubled the effective laser repetition rate and the line scanning speed, resulting in doubling both the spatial and the temporal resolution. More beamlets may be advantageous when higher pulse energy from the excitation source is available, providing greater gains in d′ value and higher spatial and temporal resolution.

An embodiment of optical beamlet-array generator 100 is used to split a laser pulse at 1320 nm into two pulses (beamlets) with ˜ 20 ns time delay, increasing the effective laser repetition rate from 2 MHz to 4 MHz. In this embodiment, optical beamlet-array generator 100 is arranged as a loop with four one-inch dielectric mirrors and a polarizing beam splitter cube (PBS). The PBS served as the input and output port of optical beamlet-array generator 100. The power distribution of each beamlet was controlled by adjusting the half-wave plate (HWP) before the PBS.

Inside the loop, two mirrors were tilted to adjust the angular separation between the beamlets. The angularly separated beamlets converge on polygon scanner 131 in a plane that was perpendicular to the scanning direction. One or more relay lenses may be placed inside the loop (along the beam paths of optical beamlet-array generator 100) to compensate for the difference in beam divergence between the beamlets. The parity of the number of relay lenses may equal the parity of the number of mirrors of the ring resonator. Two relay lenses may form an 8-f system.

Two co-planar foci that were ˜3 mm apart were created along the slow axis, which is the Y-galvo direction of FIG. 3. The fluorescence signal generated by the two beamlets is demultiplexed temporally and forms the pixels in the corresponding lines in the image. The crosstalk of the fluorescence signals between the two beamlets was measured to be ˜5%, which was caused by the data acquisition bandwidth of the system.

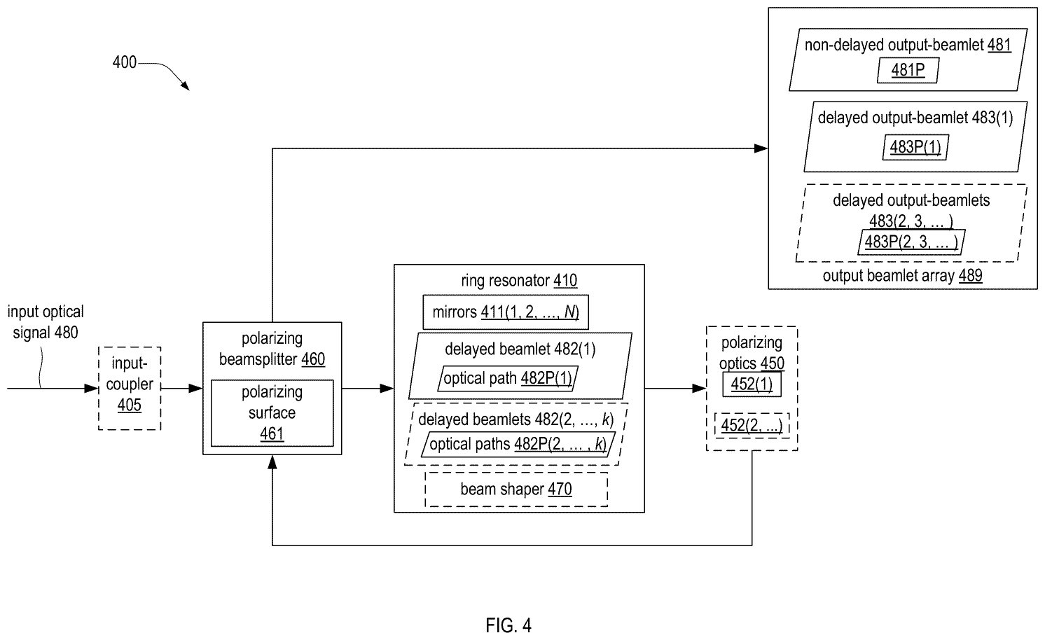

FIG. 4 is a functional block diagram of an optical beamlet generator 400. Optical beamlet-array generator 500, FIG. 4, includes a ring resonator 410 and a polarizing beamsplitter 460. Ring resonator 410 includes a plurality of mirrors 411 that at least in part define a plurality of distinct optical paths 482P within ring resonator 410. Ring resonator 410 may include one or more beam-shapers 470 to compensate for the differences in beam divergence between beamlets that propagate through a differing number of round trips ring resonator 410. Beam-shaper 470 may include one or more relay lenses, such as a pair of relay lenses, which may be configured as an 8-f system.

Polarizing beamsplitter 460 may have a beam-splitting surface 461. Herein, polarizing beamsplitter 460 denotes the beginning and end of an optical path, such as optical path 482P. Specifically, beam-splitting surface 461 may mark the beginning and end of optical paths 482P.

Polarizing beamsplitter 460 is between two mirrors 411, such as a first mirror 411(1) and a final mirror 411(N), and outputs a first polarization component of an incident optical signal 480 as a non-delayed output beamlet 481 propagating along a non-delayed output-beam path 481P. Polarizing beamsplitter 460 also outputs a second polarization component of incident optical signal 480 onto optical path 482P(1) as a delayed-beamlet 482(1) propagating toward mirror 411(1). After final mirror 411(N) reflects delayed-beamlet 482(1), polarizing beamsplitter 460 reflects the transverse electric (TE) polarization component of the delayed-beamlet 482(1) out optical path 482P(1) as a delayed-output beamlet 483(1) that propagates along a delayed output-beam path 483P(1) that is laterally offset from non-delayed output-beam path 481P. Delayed output-beam path 483P(1) may be parallel to non-delayed output-beam path 481P. Optical signal 480 may include at least one optical pulse, such that each of non-delayed output beamlet 481 and delayed-output beamlet 483 also include at least one optical pulse.

Optical beamlet generator 400 produces an output beamlet array 489 from input optical signal 480. Output beamlet array 489 includes non-delayed output beamlet 481 and delayed output beamlets 483. Beamlets output by optical beamlet generator 400 may be laterally separated by a distance comparable to the width of each non-delayed output beamlet 481 and delayed-beamlet 482. Since non-delayed output beamlet 481 and delayed-beamlets 482 are split from incident optical signal 480, their widths are equal or approximately equal—with within divergence of delayed-beamlets 482, if not compensated for by beam-shaper 470—resulting from a number of round-trips around ring resonator 410. The magnitude of lateral offsets between adjacent beam paths 483P may on the scale of the beam width of delayed output-beamlets 483.

Optical beamlet-array generator 400 may include polarizing optics 450, which includes one or more and polarization optics 452(k) on optical path 482P(k), where index k denotes a specific optical path 482P. Polarization optic 452 may be one of a half-wave plate, a quarter-wave plate, a liquid crystal device (or a region of one), a variable retarder, or an optical-fiber polarization controller. Polarization optic 452(1) is on optical path 482P(1) and modifies the polarization state of delayed-beamlet 482(1).

When optical beamlet generator 400 includes more than one polarization optic 452, polarization optic 452(2) on optical path 482P(2). In such embodiments, polarizing beamsplitter 460 transmits the TM polarization component of delayed-beamlet 482(1), transmitted by polarization optic 452(1), onto optical path 482P(2) as a delayed-beamlet 482(2) propagating toward mirror 411(1). Polarizing beamsplitter 460 also reflects the TE polarization component of delayed-beamlet 482(2), transmitted by polarization optic 452(2), out of optical path 482P(2) as a delayed-output beamlet 483(2) that propagates along a delayed output-beam path 483P(2) that is laterally offset from both non-delayed output-beam path 481P and delayed output-beam path 483P(2). At least two of beam paths 483P may be parallel.

In some embodiments, (i) the first polarization component may be transverse electric (TE) and parallel to beam-splitting surface 461, which reflects the first polarization component, and (ii) the second polarization component is TM and in a plane perpendicular to beam-splitting surface 461, which transmits the second polarization component.

In other embodiments, the first polarization component is TE and parallel to beam-splitting surface 461, which reflects the first polarization component, while the second polarization component is TM and in a plane perpendicular to the beam-splitting surface, which transmits the second polarization component. In such embodiments, optical beamlet generator 400 may include an input-coupler 405 that directs incident optical signal 480 to propagate within ring resonator 410 along an incident optical path toward polarizing beamsplitter 460. Examples of input-coupler 405 include a mirror and an optical fiber collimator. One or both of input-coupler 405 and polarization optics 450 may be between adjacent mirrors 411 of ring resonator 410, as shown in subsequent figures.

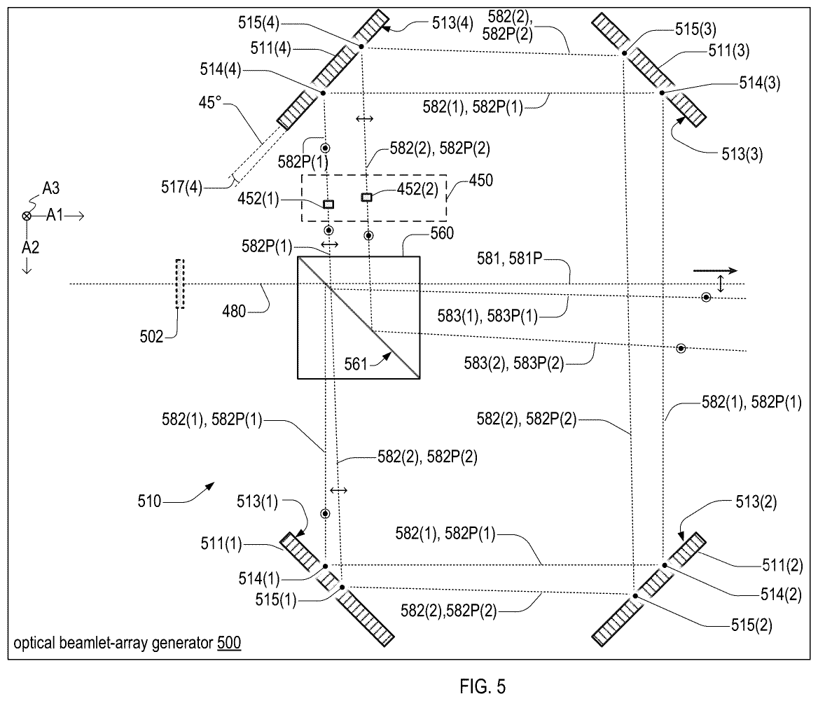

FIGS. 5-10 are respective schematics of optical beamlet generators 500, 600, 700, 800, 900, and 1000, each of which is an example of optical beamlet-array generator 100 of multiphoton microscope 190. FIG. 5 and subsequent figures depict orthogonal axes A1, A2, and A3. Unless otherwise specified, heights and depths of objects herein refer to the object's extent along axis A3. Also, herein, a horizontal plane is parallel to the A1-A2 plane, a width refers to an object's extent along axis A1 or axis A2, and a vertical direction is along axis A3.

Optical beamlet-array generators 500-1000 includes a respective ring resonator 510, 610, 710, 810, 910, and 1010, each of which includes mirrors 511(1-4). Ring resonators 510-1010 are examples of ring resonator 410 and mirrors 511 are examples of mirrors 411. Delayed-beamlets 582, 682, 782, 882, 982, and 1082 propagate along respective optical paths 582P, 682P, 782P, 882P, 982P, and 1082P within ring resonators 510-1010. These beamlets and optical paths are examples of delayed-beamlets 482 and optical paths 482P, respectively. Ring resonators 510-1010 produce respective delayed output beamlets 583, 683, 783, 883, 983, and 1083 that propagate along respective optical paths 583P, 683P, 783P, 883P, 983P, and 1083P. Beamlets 583-1083 and optical paths 583P-1083P are examples of delayed-output beamlets 483 and optical paths 483P, respectively.

Optical beamlet-array generator 500, FIG. 5, includes a ring resonator 510 and a polarizing beamsplitter 560. Ring resonator 510 includes a plurality of mirrors 511 that at least in part define a plurality of distinct optical paths 582P within ring resonator 510. In the example of optical beamlet-array generator 500, ring resonator 510 includes four mirrors: mirrors 511(1), 511(2), and 511(3), and 511(4). Without departing from the scope hereof, ring resonator 510 may include fewer mirrors (e.g., three in total) or more than four mirrors that at least in part define optical paths 582P. Ring resonator 510, mirrors 511, and optical paths 582P are examples of ring resonator 410, mirrors 411 and optical paths 482P, respectively.

Optical paths 582P include optical paths 582P(1) and 582P(2), and may include additional optical paths. Each distinct optical path 582P defines a respective quadrilateral, vertices of which are on respective reflective surfaces of mirrors 511(1), 511(2), 511(3), and 511(4). Herein, respective locations on beam-splitting surface 561 denote the beginning and end of an optical path, such as optical path 582P.

Optical beamlet-array generator 500 may include polarizing optics 450, which includes one or more and polarization optics 452(k) on optical path 582P(k), where index k denotes the optical path. For example, optical beamlet-array generator 500 may include one or both of polarization optics 582P(1) and 582P(2). While each polarization optic 452 is illustrated as being on a respective optical path 582P between mirror 511(4) and polarizing beamsplitter 560, a polarization optic 452(k) may be at different location on optical path 582P(k).

Polarizing beamsplitter 560 is between mirror 511(1) and 511(4) outputs a first polarization component of incident optical signal 480 as a non-delayed output beamlet 581 propagating along a non-delayed output-beam path 581P. Non-delayed output beamlet 581 and non-delayed output-beam path 581P are respective examples of non-delayed output beamlet 481 and non-delayed output-beam path 481P.

Polarizing beamsplitter 560 also outputs a second polarization component of incident optical signal 480 onto optical path 582P(1) as a delayed-beamlet 582(1) propagating toward mirror 511(1), which reflects delayed-beamlet 582(1) to mirror 511(2). Mirror reflects 511(2) delayed-beamlet 582(1) to mirror 511(3), which reflects the delayed-beamlet 582(1) to mirror 511(4), which reflects delayed-beamlet 582(1) to polarizing beamsplitter 560.

Polarizing beamsplitter 560 reflects the transverse electric (TE) polarization component of delayed-beamlet 582(1) out of optical path 582P(1) as a delayed-output beamlet 583(1) that propagates along a delayed output-beam path 483P(1) that is laterally offset from non-delayed output-beam path 481P. Delayed output-beam path 483P(1) may be parallel to non-delayed output-beam path 481P.

Polarizing beamsplitter 560 has a beam-splitting surface 561, which is perpendicular to the A1-A2 plane. Mirrors 511(1-4) have respective reflective surfaces 513(1-4). Beam-splitting surface 561 may be (i) parallel to at least one of surfaces 513(1) and 513(3) and (ii) perpendicular to at least one of reflective surfaces 513(2) and 513(4).

A reflective surface 513 may be planar or non-planar, e.g., concave. Herein, a planar surface's being parallel (perpendicular) to a concave surface means that the planar surface is perpendicular (parallel) to a symmetry axis or symmetry plane of the concave surface. Also herein, two concave surfaces are (i) parallel when their respective symmetric planes or axes are parallel and (ii) perpendicular when their respective symmetric planes or axes are perpendicular.

Herein, transverse electric (TE) polarization transverse magnetic (TM) polarization components refer to linear polarization components perpendicular to the A1-A2 plane and parallel to the A1-A2 plane, respectively. Selected beamlets shown in FIG. 5 and subsequent figures are annotated with a circled bullet (⊙) and/or a double-arrow (↔), which denote that the beamlet includes TE and TM polarizations, respectively.

Polarizing beamsplitter 560 may be a polarizing beamsplitter cube. Optical beamlet-array generator 500 may include a polarizing optic 502 for controlling the polarization state of incident optical signal 480. In optical beam generators 500-1000, the first polarization component is TM and the second polarization component is TE.

In embodiments, optical beamlet-array generator 500 generates one or more additional output beams 583, such as output beam 583(2) shown in FIG. 5. In such embodiments, polarizing beamsplitter 560 transmits the TM polarization component of delayed-beamlet 582P(1), transmitted by polarization optic 452(1), onto optical path 582P(2) as a delayed-beamlet 582(2) propagating toward mirror 511(1). Polarizing beamsplitter 560 reflects the TE polarization component of delayed-beamlet 582(2), transmitted by additional polarization optic 452(2), out of optical path 582P(2) as a delayed-output beamlet 583(2) that propagates along a delayed output-beam path 483P(2) that is laterally offset from both non-delayed output-beam path 481P and delayed output-beam path 483P(1).

Delayed-beamlet 582(1) incident on respective locations 514(1), 514(2), 514(3), and 514(4) of reflective surfaces 513(1), 513(2), 513(3), and 513(4). Locations 514 correspond to corners of a rectangle. In optical beamlet-array generator 500-1000, respective delayed-beamlets 682(1)-1082(1) are incident on respective locations 614, 714, 814, 914, and 1014, which are analogous to locations 514(1-4).

Ring resonator 510 produces laterally offset output beams 583, as a result of one of mirrors 511 being translated or rotated, relative to the stable configuration, such that locations 514 correspond to corners of a non-rectangular quadrilateral. In optical beamlet-array generator 500, mirror 511(4) is tilted by a deviation angle 517(4) relative to being parallel to reflective surface 513(2). This results in delayed-beamlet 582(2) being incident on mirrors 511(1-4) at respective locations 515(1-4). Location 515(1) is offset from location 514(1) along axis A1 and. Locations 515(1-4) correspond to corners of a non-rectangular quadrilateral, which results in ring resonator 510 being unstable.

While deviation angles 517 are relative to mirrors 511 being parallel or perpendicular to a different mirror 511, deviation angles may be defined more broadly. For example, a deviation angle of a mirror 411 herein may refer to the angular deviation of the mirror's orientation relative to angular orientations that yield a stable configuration of the ring resonator.

Herein, an optical resonator is unstable when successive round-trip optical paths of a beam around the cavity do not overlap, such that eventually the beam's optical path does not intersect with a mirror of the resonator and hence the beam exits the resonator. In embodiments, one of polarization optics 452 is configured to convert a TM-polarized delayed-beamlet (e.g., beamlet 582(2)) to a TM-polarized delayed-beamlet, such that polarizing beamsplitter 560 reflects all of the beamlet out of the resonator as an output beamlet, which prevents the beamlet from missing a mirror.

A four-mirror optical resonator that includes mirrors 511 may be unstable as a result of different geometric layouts that result in non-rectangular beam paths within the cavity. For example, in embodiments, at least one of (i) surfaces 513(1) and 513(3) are not parallel and (ii) surfaces 513(2) and 513(4) are not parallel. Similarly, in embodiments, at least one of (i) a distance between mirror 511(1) and mirror 511(4) differs from a distance between mirror 511(2) and mirror 511(3), and (ii) a distance between mirror 511(1) and mirror 511(2) differs from a distance between the third mirror 511(3) and the final mirror 511(4).

As in output beamlets 583, respective output beamlets 683-1083 of resonators 610-1010 are laterally offset as a result of at least one of mirrors 511 being translated and/or rotated, relative to the stable configuration, such that locations 614, 714, 814, 914, and 1014, correspond to corners of a non-rectangular quadrilateral.

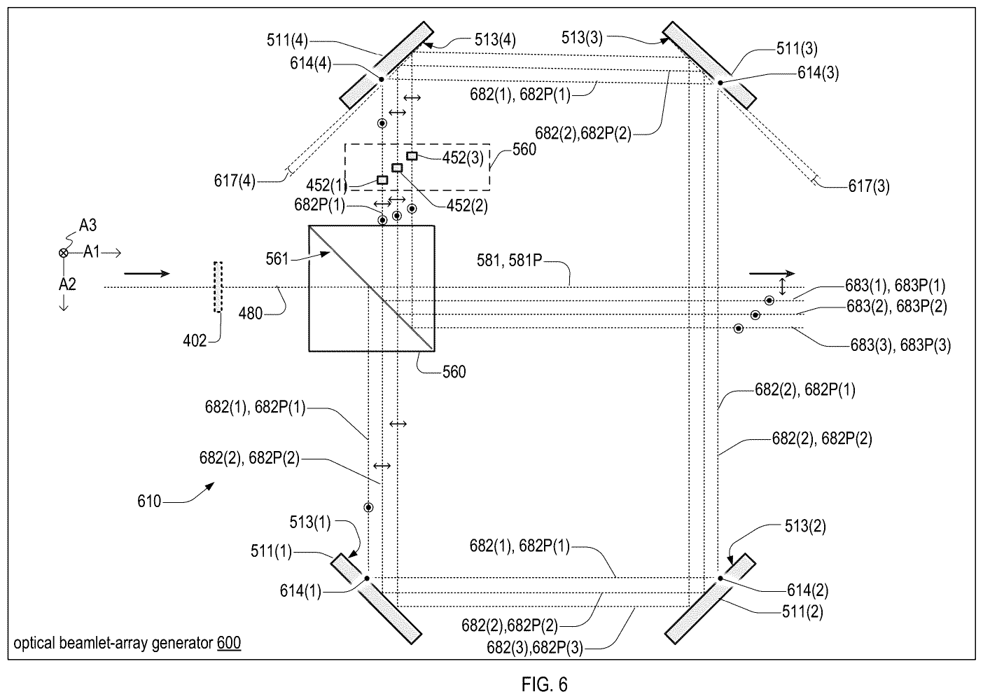

Optical resonator 610, FIG. 6, produces non-delayed output beamlet 581 and delayed-beamlets 682 from incident optical signal 480. In optical resonator 610, mirror 511(3) is tilted by a deviation angle 617(3) relative to being parallel to reflective surface 513(1). Similarly, mirror 511(4) is tilted by a deviation angle 617(4) relative to being parallel to reflective surface 513(2). These tilts result in ring resonator 610 being unstable. In optical resonator 610, delayed-beamlets 682(1-3) propagate along respective optical paths 682P(1-3), each of which are non-rectangular, e.g., trapezoidal, as defined by points on reflective surfaces 513 at which these paths are incident. When deviation angles 617 have equal magnitude, sections of optical paths 682P between mirrors 511(4) and 511(1) are parallel to sections of optical paths 682P between mirrors 511(2) and 511(4) and the shape of each optical beam path 682P is a part of right trapezoid, and locations 614(1-4) correspond to corners of a right trapezoid.

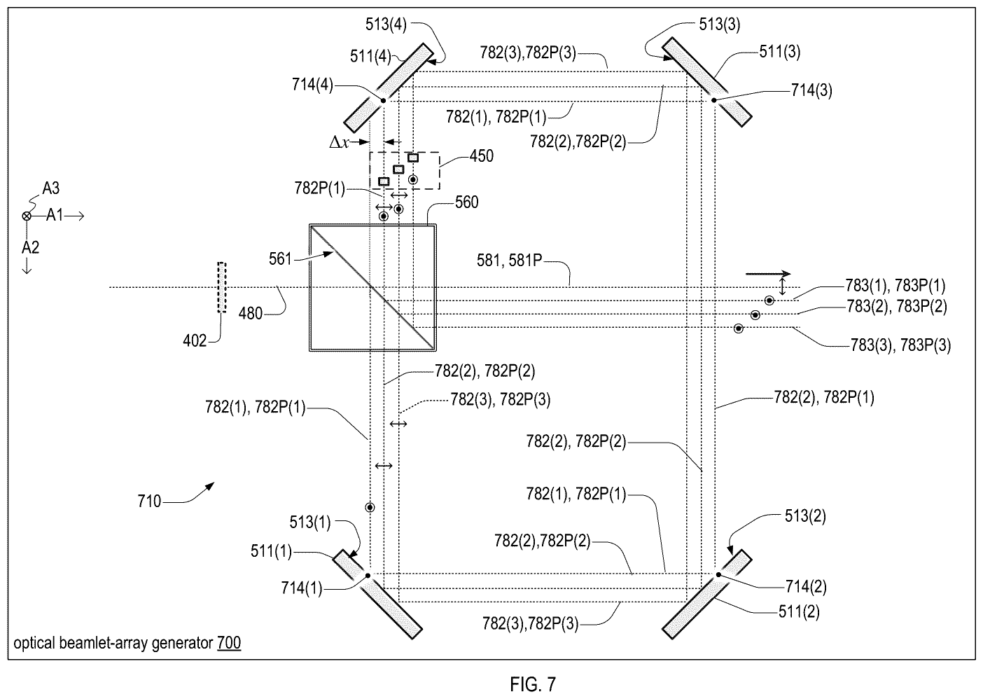

Optical resonator 710, FIG. 7, produces non-delayed output beamlet 581 and delayed-beamlets 782 from incident optical signal 480. In optical resonator 710, mirror 511(3) is translated by a distance Δx along axis A1, which results in ring resonator 710 being unstable. In optical resonator 710, delayed-beamlets 782(1-3) propagate along respective optical paths 782P(1-3), each of which is trapezoidal as defined by points on reflective surface 513 at which these paths are incident. For example, locations 714(1-4) correspond to corners of a right trapezoid, as location 714(4) is laterally offset from point 714(1) along axis A1 by distance Δx

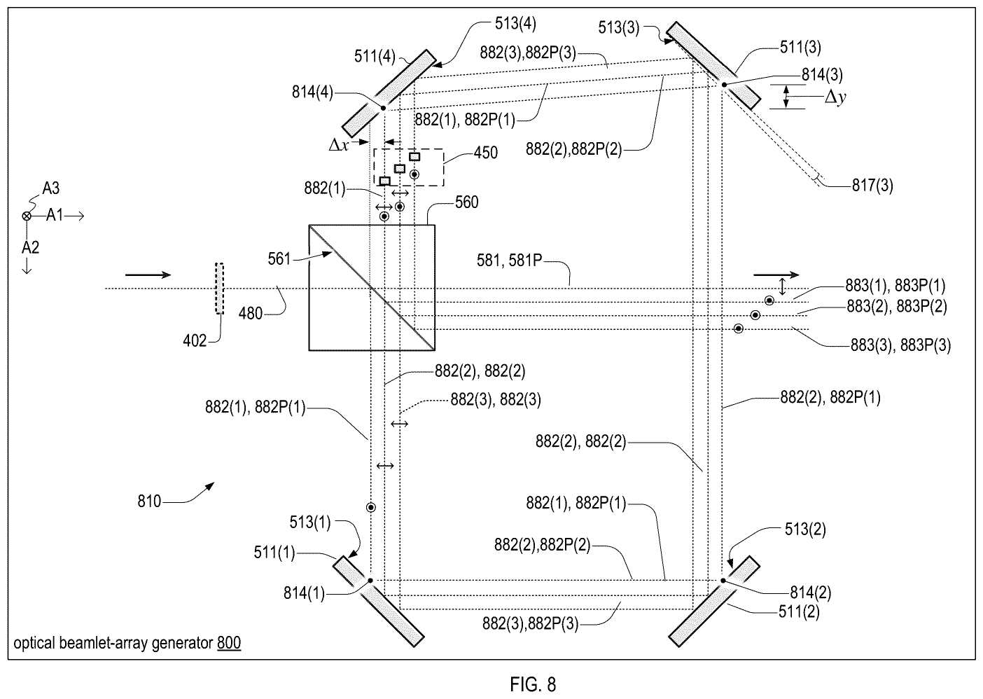

Optical resonator 810, FIG. 8, produces non-delayed output beamlet 581 and delayed output beamlets 883 from incident optical signal 480. In optical resonator 810, as in optical resonator 710, mirror 511(3) is translated by distances Δx and Δy along axes A1 and A2, respectively. As in optical resonator 610, mirror 511(3) of optical resonator 810 is tilted by a deviation angle 817(3) relative to being parallel to reflective surface 513(1). Deviation angle 817(3) is an example of deviation angle 517(4) and 617(3).

In optical resonator 810, delayed-beamlets 882(1-3) propagate along respective optical paths 882P(1-3), each of which is non-rectangular as defined by points on reflective surface 513 at which these paths are incident. For example, locations 814(1-4) correspond to corners of an irregular quadrilateral, as location 814(4) is both (i) laterally offset from point 814(1) along axis A1 by distance Δx (ii) laterally offset from point 814(3) along axis A2 by distance Δy. In optical resonator 810, surfaces 513(2) and 513(4) may be parallel, and surface 513(1) may be perpendicular to surface 513(2) and 513(4), such that sections of beam paths 882P between mirrors 511(4) and 511(1) are parallel to sections of beam paths 882P between mirrors 511(2) and 511(3).

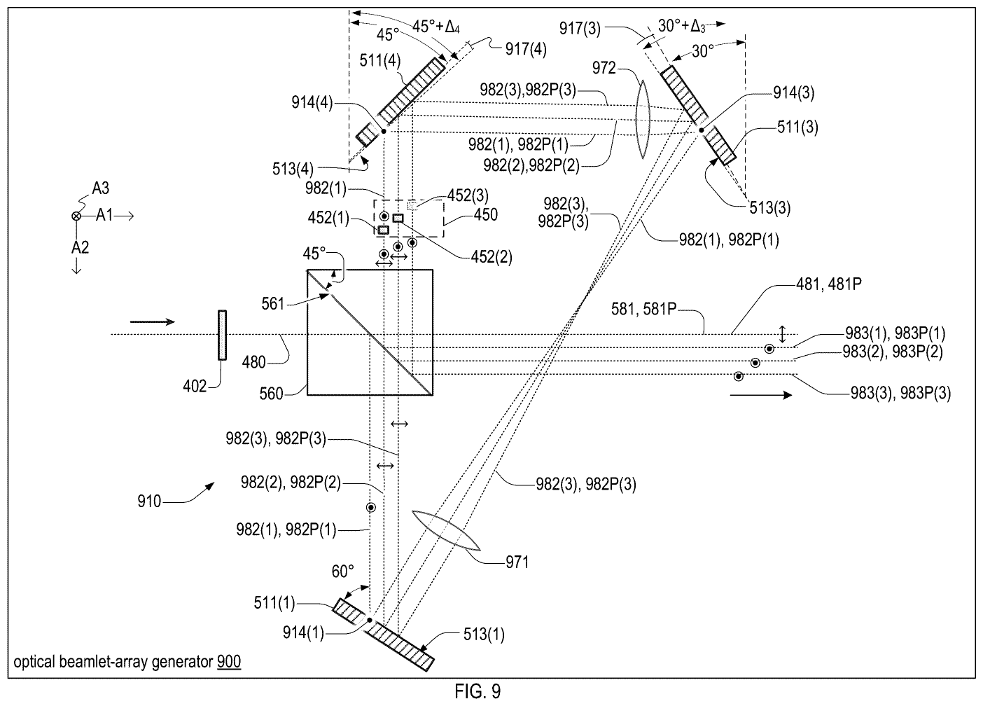

Optical resonator 910, FIG. 9, is a triangular resonator that includes three mirrors, which are designated as mirrors 511(1), 511(3), and 511(4) for consistency with optical resonators 510-810. That is, respective ring resonator 910 may be obtained by removing mirror 511(2) from one of resonators 510-810 and tilting mirror 511(1) to reflect delayed-beamlets to mirror 511(3). In optical resonator 910, delayed-beamlets 982(1-3) propagate along respective optical paths 982P(1-3).

Optical beamlet generator 900 produces non-delayed output beamlet 581 and delayed output beamlets 983(1-3) from incident optical signal 480. Delayed output beamlets 983(1-3) propagate along respective beam paths 983P(1-3). Each beam path 983P defines a respective triangle, vertices of which are on respective reflective surfaces 513 of mirrors 511(1, 3, 4)

Ring resonator 910 includes a relay lens 970, which is an example of beam-shaper 470. In the example of FIG. 9, relay lens 970 includes lenses 971 and 972 separated within respective ring resonator 910 by a sum of their respective focal lengths. Relay lens 970 flips the orientation of delayed-beamlets 982 such that (i) delayed-beamlets 982(1), 982(2), and 982(3) are incident on beam-splitting surface 561 at locations having an increasing distance from where incident optical signal 480 is incident on beam-splitting surface 561. Absent second relay lens 970, beam paths 982P(1) and 982P(3) would be switched between mirror 511(4) and polarizing beamsplitter 560. This would result in a larger spacing between adjacent delayed output beamlets 983, and also require mirrors 511 and polarizing beamsplitter 560 to be larger to accommodate this larger inter-beam spacing.

In embodiments, and as shown in FIG. 9, beam-splitting surface 561 and reflective surface 513(1) are oriented, respectively, at a 45° angle and a 60° angle, with respect to axis A2. When beam path 982P(1) is parallel to axes A2 between mirrors 511(4) and 511(3), ring resonator 910 would be a stable resonator for beamlets 983 when reflective surfaces 513(3) and 513(4) are oriented at 30° and 60° respectively with respect to axis A2. However, as shown in FIG. 9, each of mirrors 511(3) and 511(4) are tilted slightly by respective deviation angles 917(3) and 917(4) from these values, such that beam paths 982P are non-overlapping. For clarity of illustration, FIG. 9 denotes deviation angles 917(3) and 917(4) as 43 and 44, respectively. Deviation angles 917(3) and 917(4) may have equal magnitude such that delayed output beamlets 983 propagate parallel to axis A2 between mirrors 511(4) and 511(1), as shown in FIG. 9.

The deviation angle of a mirror 411 may be positive or negative, and have a magnitude greater than or equal to a minimum deviation and less than or equal to a maximum deviation. Examples of this deviation angle includes deviation angles 517, 617, 817, and 917. In embodiments, the minimum deviation is one of: one degree, two degrees, three degrees, or four degrees. The maximum deviation may be five degrees.

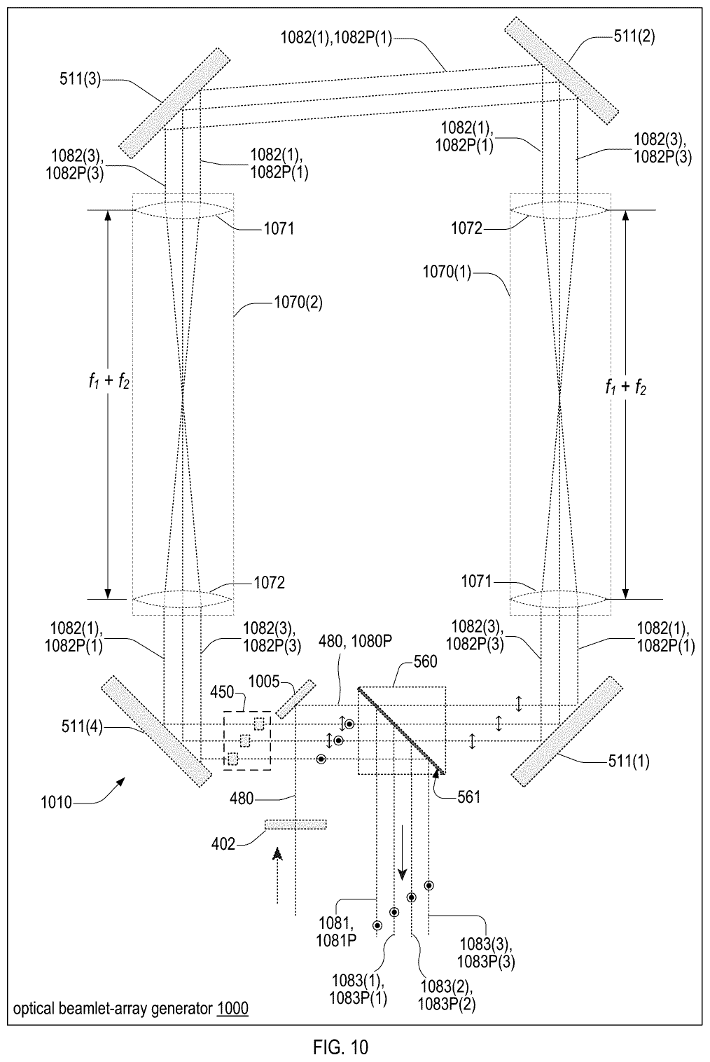

Optical resonator 1010, FIG. 10, produces non-delayed output beamlet 581 and delayed output beamlets 1083 from incident optical signal 480. Ring resonator 1010 is one of ring resonators 510-810.

Ring resonator 1010 may include one or more beam-shapers 1070. Beam-shaper 1070 may be a relay lens that includes two coaxially aligned lenses 1071 and 1072, having respective focal lengths f₁ and f₂, that are axially separated by the sum f₁+f₂. Lenses 1071 and 1072 may have the same focal length such that beam-shaper 1070 has unity magnification.

When beam-shaper 1070 is a relay lens, which creates inverted images, beam-shaper 1070 inverts delayed-beamlets 1082 For example, prior to reaching beam-shaper 1070(1), beam paths 1082P(1) and 1082(3) an “outside” path and “inside” path, respectively. These positions are switched after beam-shaper 1070(1). Accordingly, beam-shaper 1070(2) returns beam paths 1082P to their original positions. Absent second beam-shaper 1070(2), beam paths 1082P(1) and 1082P(3) would be switched between mirror 511(4) and polarizing beamsplitter 560. This would result in a larger spacing between adjacent delayed output beamlets 1083, and also require mirrors 511 and polarizing beamsplitter 560 to be larger to accommodate this larger inter-beam spacing.

Accordingly, in embodiments when the total number of mirrors of ring resonator 1010 is even, it may also include an even number (e.g., two) of beam-shapers 1070. Similarly, when the total number of mirrors of ring resonator 1010 is odd, it may also include an odd number (e.g., one) of beam-shapers 1070.

Optical beamlet generator 1000 includes an input-coupler 1005, which is an example of input-coupler 405. Input-coupler 1005 that directs incident optical signal 480 to propagate within ring resonator 1010 along an incident optical path 1080P toward polarizing beamsplitter 560, which reflects incident optical signal 480 as a non-delayed output beamlet 1081, which propagates along a beam path 1081P and is an example of non-delayed output beamlet 481. Non-delayed output beamlet 1081 is TE polarized, whereas non-delayed output beamlets 581 are TM polarized.

Since optical beamlet generator 1000 includes input-coupler 1005, beam-splitting surface 561 is parallel to reflective surface 513(1) and perpendicular to reflective surface 513(2). By contrast, in beam generators 500-900, which lack input-coupler 1005, polarizing beamsplitter 560 oriented differently, such that beam-splitting surface 561 is perpendicular to reflective surface 513(1) and parallel to reflective surface 513(2).

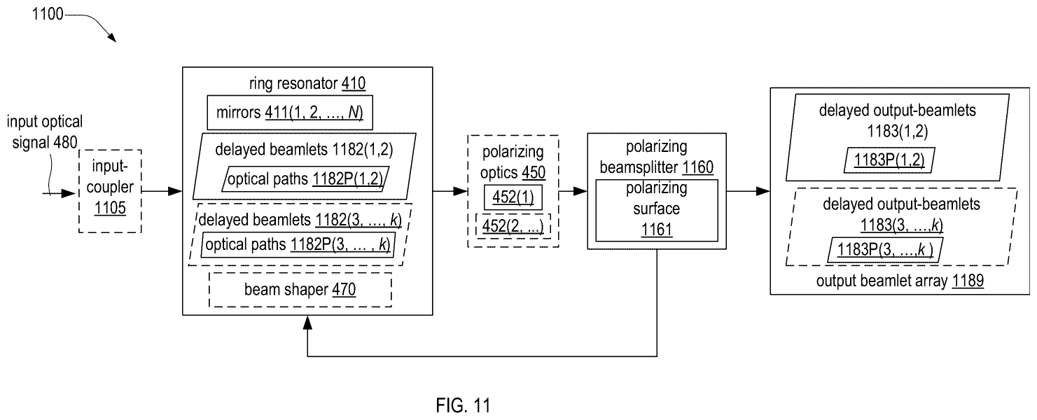

FIG. 11 is a block diagram of an optical beamlet generator 1100, which includes ring resonator 410, an input-coupler 1105, polarizing beamsplitter 1160, and a polarization optic 452. Input-coupler 1105 and polarizing beamsplitter 1160 may be within ring resonator 410. For example, input-coupler 1105 may be between polarizing beamsplitter 1160 and adjacent mirrors 411 of ring resonator 410. Input-coupler 1105 is an example of input-coupler 405.

Optical beamlet generator 1100 produces an output beamlet array 1189 from input optical signal 480. Output beamlet array 1189 includes delayed output beamlets 1183. While polarizing beamsplitter 1160 of optical beamlet generator 1100 may be similar or identical to polarizing beamsplitter 460 of optical beamlet generator 400, the respective beamsplitters of optical beamlet generators 400 and 1100 are assigned different reference numbers (460 and 1160) because they perform similar, but not identical functions. Polarizing beamsplitter 1160 has a polarizing surface 1161, which is analogous to beam-splitting surface 461.

Input-coupler 1105 directs incident optical signal 480 to propagate, as a delayed-beamlet 1182(1), within ring resonator 410 along at least part of a first optical path 1182P(1) of the plurality of distinct optical paths 1182P within ring resonator 410. Polarizing beamsplitter 1160 (i) is between a mirror 411(1) and a final mirror 411(N) of the plurality of mirrors 411, (i) reflects the transverse electric (TE) polarization component of delayed-beamlet 1182(1) as a delayed output beamlet 1183(1) propagating along a delayed output-beam path 1183P(1), (ii) transmits the transverse magnetic (TM) polarization component of delayed-beamlet 1182(1) onto a second optical path 1183P(2) of the plurality of distinct optical paths 1183P as a delayed-output beamlet 1183(2) propagating toward mirror 411(1) and (iii) after mirror 411(N) reflects delayed-beamlet 1182(2), reflects the transverse electric (TE) polarization component of delayed-beamlet 1182(2) out of optical path 1182P(2) as an additional delayed-output beamlet 1183(2) that propagates along an additional delayed output-beam path 1183P(2) that is laterally offset from delayed output-beam path 1183P(1). Polarization optic 452 is on optical path 1182P(2) and modifies the polarization state of delayed-beamlet 1182(2). The magnitude of lateral offsets between adjacent beam paths 1183P may on the scale of the beam width of delayed output-beamlets 1183.

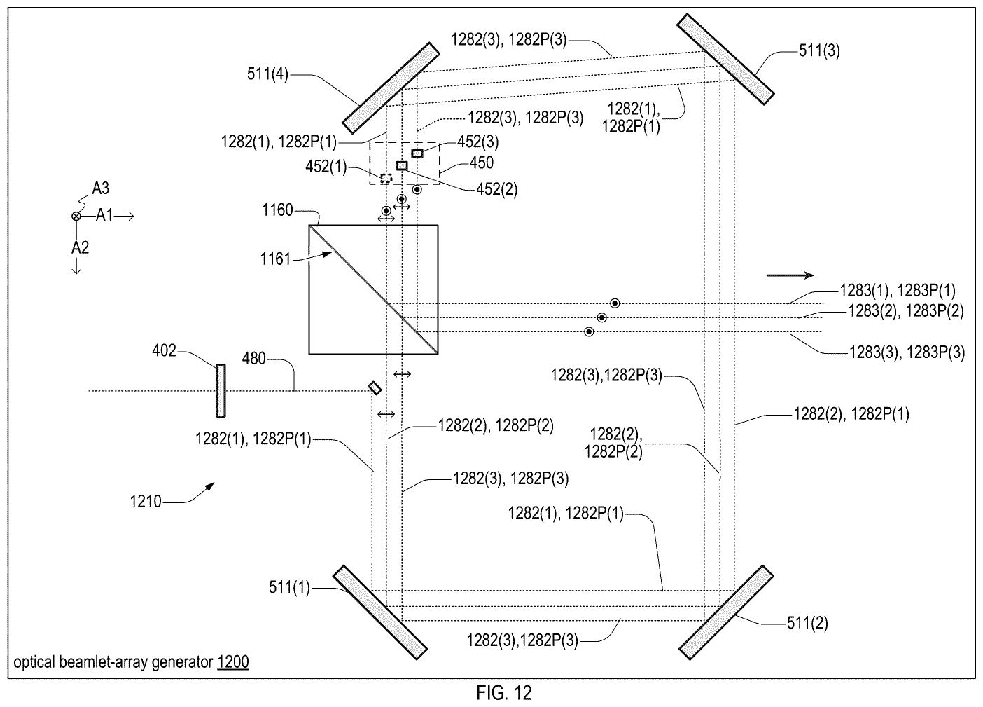

FIG. 12 is a schematic of an optical beamlet generator 1200, which is an example of optical beamlet generator 1100. Optical beamlet generator 1200 includes a ring resonator 1210, which is an example of ring resonator 410 and hence may be any one of ring resonators 510, 610, 710, 810, 910, and 1010. While ring resonator 1210 is illustrated as including for mirrors 411, the total number of mirrors 411 of 1210 may fewer than four, e.g., three as in ring resonator 910, or more than four.

In optical beamlet generator 1200, input-coupler 1105 directs incident optical signal 480 to propagate, as a delayed-beamlet 1282(1), within ring resonator 410 along at least part of a first optical path 1282P(1) of the plurality of distinct optical paths 1282 within ring resonator 410. Polarizing beamsplitter 1160 is between a mirror 511(1) and mirror 511(4) and (i) reflects the transverse electric (TE) polarization component of delayed-beamlet 1282(1) as a delayed output beamlet 1283(1) propagating along a delayed output-beam path 1283P(1), (ii) transmits the transverse magnetic (TM) polarization component of delayed-beamlet 1282(1) onto a second optical path 1282P(2) of the plurality of distinct optical paths 1282P as a delayed beamlet 1282(2) propagating toward mirror 511(1). After mirror 511(4) reflects delayed-beamlet 1282(2), polarizing beamsplitter 1160 reflects the transverse electric (TE) polarization component of delayed-beamlet 1282(2) out of optical path 1282P(2) as an additional delayed-output beamlet 1283(2). Delayed-output beamlet 1283(2) propagates along an additional delayed output-beam path 1283P(2) that is laterally offset from delayed output-beam path 1283P(1).

Optical beamlet-array generator 100 includes polarization optic 452(2) on optical path 1282P(2), which modifies the polarization state of delayed-beamlet 1282(2). Optical beamlet-array generator 1200 may also include polarization optic 452(1) on optical path 1282P(1) and modifies the polarization state of delayed-beamlet 1282(1).

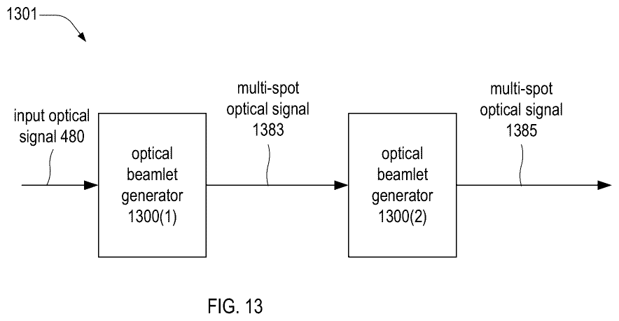

FIG. 13 is a block diagram of a cascaded optical beamlet-array generator 1301, which includes optical beamlet generators 1300(1) and 1300(2). Both optical beamlet generator 400 and optical beamlet generator 1100 are examples of beam generators 1300(1) and 1300(2). In optical beamlet generator 1300(1), (i) the delayed output-beam path is laterally offset from the non-delayed output-beam path in a first direction and (ii) the non-delayed output beamlet and the delayed-output beamlet form a multi-spot optical signal 1383. Examples of multi-spot optical signal 1383 include delayed output-beamlets 483 and delayed output-beamlets 1183. When optical signal 1383 includes delayed output-beamlets 483, it may also include non-delayed output beamlet 481.

Optical beamlet generator 1300(2), receives, as its incident optical signal 480, multi-spot optical signal 1383, and outputs, as its output beamlets, a multi-spot optical signal 1185. Multi-spot optical signal 1385 includes multi-spot optical signal 1383, a third output beamlet, and (a fourth output beamlet that is laterally offset from the third output beamlet in a second direction perpendicular to the first direction. Multi-spot optical signal 1385 may include a two-dimensional array of beamlets, e.g., an m×n array, where at least one of m and n is greater than or equal to two.

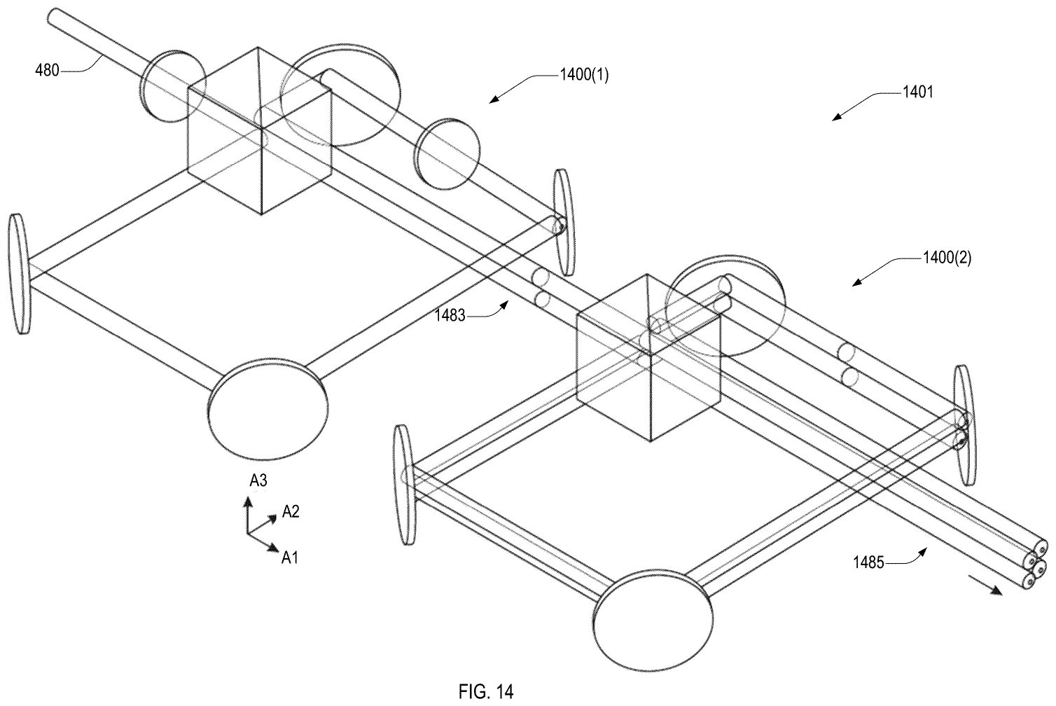

FIG. 14 is a schematic of a cascaded optical beamlet-array generator 1401, which is an example of cascaded optical beamlet-array generator 1301. Cascaded optical beamlet-array generator 1401 includes a four-mirror beamlet-array generators 1400(1) and 1400(2), examples of which include optical beamlet-array generators 500-800. Cascaded optical beamlet-array generator 1400(1) outputs a multi-spot optical signal 1483 from incident optical signal 480. Cascaded optical beamlet-array generator 1400(2) outputs a multi-spot optical signal 1485 from multi-spot optical signal 1483. Signals 1483 and 1485 are respective examples of multi-spot optical signal 1383 and multi-spot optical signal 1385.

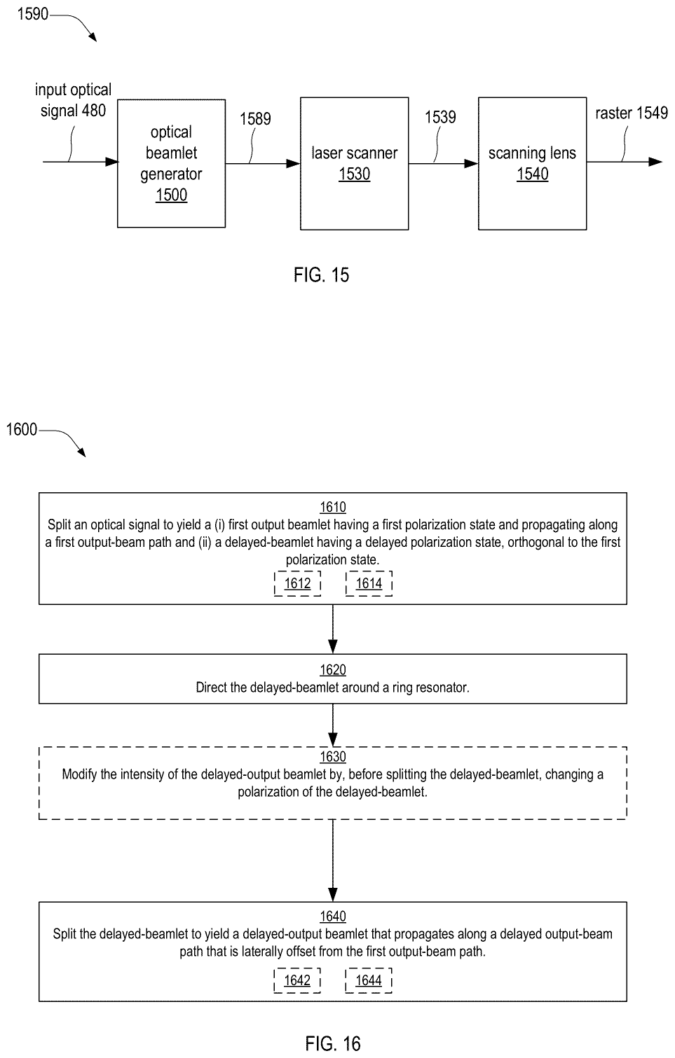

FIG. 15 is a block diagram of microscope 1590, which includes an optical beamlet generator 1500, a laser scanner 1530, and a scanning lens 1540. Laser scanner 1530 is between the polarizing beamsplitter of optical beamlet generator 1500 and scanning lens 1540 on the delayed output-beam path of optical beamlet generator 1500. Multiphoton microscope 190, FIG. 1, is an example of microscope 1590. Optical beamlet generator 400 and optical beamlet generator 1100 are examples of optical beamlet generator 1500. Optical beamlet generator 1500 outputs output beamlet array 1589, examples of which include output beamlet array 489 and output beamlet array 1189. Laser scanner 1530 steers, through an angular range in a plane, output beamlets 1583 to yield steered output beamlets 1539. Scanning lens 1540 focuses steered output beamlets 1539 to a focused spot that traces a raster 1549 in an image plane of scanning lens 1540. Since outputs output beamlet array 1589 includes multiple beamlets, denoted by N≥2, the scanning speed of microscope 1590 for capturing an image with a raster, is N times faster than a comparable microscope where N=1.

FIG. 16 is a flowchart illustrating an optical beamlet-array generation method 1600. Method 1600 may be implemented with optical beamlet generator 400 or 1100. Method 1600 includes at least one of steps 1610, 1620, and 1640.

The following description of method 1600 includes parenthetical numbers following terms used in a method step. The parenthetical number indicates that the element associated with the number in parenthesis is an example of the term. For example, the description of step 1610 below recites “an optical signal (480) which means incident optical signal 480 introduced in FIG. 4 is an example of the optical signal introduced in step 1610.

Step 1610 includes splitting an optical signal (480) to yield a (i) first output beamlet (481, 1183(1)) having a first polarization state and propagating along a first output-beam path (481P, 1183(1) P) and (ii) a delayed-beamlet (482(1), 1182(1)) having a delayed polarization state, orthogonal to the first polarization state.

Step 1620 includes directing the delayed-beamlet around a ring resonator (410). Step 1640 follows step 1620, and includes splitting the delayed-beamlet to yield a delayed-output beamlet (483(1), 1183(2)). The delayed-output beamlet propagates along a delayed output-beam path (483P(1), 1183P(2)) that is laterally offset from the first output-beam path.

In embodiments, splitting the optical signal (step 1610) includes step 1612. Step 1612 includes (i) transmitting the TM polarization component of the optical signal to yield the first output beamlet (581) and (ii) reflecting the TE polarization component of the optical signal to yield the delayed-beamlet (582(1)). In other embodiments, the splitting of step 1610 includes step 1614. Step 1614 includes (i) reflecting the TE polarization component of the optical signal to yield the first output beamlet (1081, 1183(1))) and (ii) transmitting the TM polarization component of the optical signal to yield the delayed-beamlet (1082(1), 1182(2))).

Method 1600 may also include step 1630. Step 1630 includes modifying the intensity of the delayed-output beamlet by, before splitting the delayed-beamlet (482(1)), changing a polarization of the delayed-beamlet, e.g., with a polarization optic 452.

In embodiments, the delayed-beamlet has a transverse electric (TE) polarization component and a transverse magnetic (TM) polarization component. In such embodiments, the splitting the delayed-beamlet (step 1640) includes step 1642. Step 1642 includes reflecting the TE polarization component to yield the delayed-output beamlet (583(1)) and transmitting the TM polarization component of the delayed-beamlet to yield an additional delayed-beamlet (582(2)).

When step 1640 includes 1642, it may also include a step 1644. Step 1644 includes directing the additional delayed-beamlet (582(2)) around the ring resonator (410). Step 1644 also includes, after directing the additional delayed-beamlet (582(2)), splitting the additional delayed-beamlet to yield an additional delayed-output beamlet (583(2)). The additional delayed output beamlet propagates along an additional delayed output-beam path (583P(2)) that is laterally offset from both the first output-beam path (581P) and the delayed output-beam path (583P(1)).

Features described above, as well as those claimed below, may be combined in various ways without departing from the scope hereof. The following enumerated examples illustrate some possible, non-limiting combinations.

Embodiment 1. An optical beamlet-array generator includes: a ring resonator including a plurality of mirrors that in part define a plurality of distinct optical paths within the ring resonator; a polarizing beamsplitter that (i) is between a first mirror and a final mirror of the plurality of mirrors, (ii) outputs a first polarization component of an incident optical signal as a non-delayed output beamlet propagating along a non-delayed output-beam path, (iii) outputs a second polarization component of the incident optical signal onto a first optical path of a plurality of distinct optical paths as a first delayed-beamlet propagating toward the first mirror and (iv) after the final mirror reflects the first delayed-beamlet, reflects the transverse electric (TE) polarization component of the first delayed-beamlet out of the first optical path as a delayed-output beamlet that propagates along a delayed output-beam path that is laterally offset from the non-delayed output-beam path; and a polarization optic, on the first optical path, that modifies the first delayed-beamlet's polarization state.

Embodiment 2. The optical beamlet-array generator of embodiment 1, the polarizing beamsplitter having a beam-splitting surface; the first polarization component being transverse magnetic (TM) and in a plane perpendicular to the beam-splitting surface, which transmits the first polarization component; and the second polarization component being TE and parallel to the beam-splitting surface, which reflects the second polarization component.

Embodiment 3. The optical beamlet-array generator of either one of embodiments 1 or 2, the polarizing beamsplitter having a beam-splitting surface; the first polarization component being TE and parallel to the beam-splitting surface, which reflects the first polarization component; and the second polarization component being TM and in a plane perpendicular to the beam-splitting surface, which transmits the second polarization component.

Embodiment 4. The optical beamlet-array generator of any one of embodiments 1-3, further includes: an input-coupler that directs the incident optical signal to propagate within the ring resonator along an incident optical path toward the polarizing beamsplitter.

Embodiment 5. The optical beamlet-array generator of any one of embodiments 1-4, the second polarization component being the TM polarization component, and further includes: an additional polarization optic on a second optical path of the plurality of distinct paths, wherein: the polarizing beamsplitter (v) transmits the TM polarization component of the first delayed-beamlet, transmitted by the polarization optic, onto the second optical path as a second delayed-beamlet propagating toward the first mirror and (vi) reflects the TE polarization component of the second delayed-beamlet, transmitted by the additional polarization optic, out of the second optical path as an additional delayed-output beamlet that propagates along an additional delayed output-beam path that is laterally offset from both the non-delayed output-beam path and the delayed output-beam path.

Embodiment 6. The optical beamlet-array generator of any one of embodiments 1-5, the plurality of mirrors further including a second mirror and a third mirror, wherein the second mirror reflects the first delayed-beamlet to the third mirror, which reflects the first delayed-beamlet to the final mirror, which reflects the first delayed-beamlet to the polarizing beamsplitter; each of the plurality of distinct optical paths defining a respective quadrilateral, vertices of which are on respective reflective surfaces of the first mirror, the second mirror, the third mirror, and the final mirror.

Embodiment 7. The optical beamlet-array generator of any one of embodiments 1-6, the first mirror and the third mirror having, respectively, a first reflective surface and a third reflective surface, a beam-splitting surface of the polarizing beamsplitter being parallel to at least one of the first reflective surface and the third reflective surface.

Embodiment 8. The optical beamlet-array generator of any one of embodiments 1-7, the second mirror and the final mirror having, respectively, a second reflective surface and a final reflective surface, a beam-splitting surface of the polarizing beamsplitter being perpendicular to at least one of the second reflective surface and the final reflective surface.

Embodiment 9. The optical beamlet-array generator of any one of embodiments 1-8, the ring resonator being unstable, at least one of the plurality of mirrors having an angular orientation that deviates from an angular orientation required for the ring resonator to be stable, each of the respective quadrilaterals may be a non-rectangular quadrilateral.

Embodiment 10. The optical beamlet-array generator of any one of embodiments 1-9, the first mirror, the second mirror, the third mirror, and the final mirror having, respectively, a first reflective surface, a second reflective surface, a third reflective surface, and a final reflective surface, and at least one of: the first reflective surface and the third reflective surface being nonparallel; and the second reflective surface and the final reflective surface being nonparallel, wherein either (i) each of the respective quadrilaterals may be a trapezoid or (ii) each of the respective quadrilaterals may be an irregular quadrilateral.

Embodiment 11. The optical beamlet-array generator of any one of embodiments 1-10, the ring resonator being unstable by virtue of at least one of: a distance between the first mirror and the final mirror differing from a distance between the second mirror and the third mirror; and a distance between the first mirror and the second mirror differing from a distance between the third mirror and the final mirror, wherein each of the respective quadrilaterals may be a trapezoid.

Embodiment 12. The optical beamlet-array generator of any one of embodiments 1-11, the plurality of mirrors further includes a second mirror, wherein the second mirror reflects the first delayed-beamlet to the final mirror, which reflects the first delayed-beamlet to the polarizing beamsplitter, each of the plurality of distinct optical paths defining a respective triangle, vertices of which are on respective reflective surfaces of the first mirror, the second mirror, and the final mirror.

Embodiment 13. A cascaded optical beamlet-array generator includes: a first optical beamlet generator of any one of embodiments 1-12, where (i) the delayed output-beam path is laterally offset from the non-delayed output-beam path in a first direction, and (ii) the non-delayed output beamlet and the delayed-output beamlet form a multi-spot optical signal; and a second optical beamlet generator of claim 1 that receives, as its incident optical signal, the multi-spot optical signal, and outputs, as its output beamlets, a third output beamlet and a fourth output beamlet that is laterally offset from the third output beamlet in a second direction that is perpendicular to the first direction.

Embodiment 14. A microscope includes: an optical beamlet generator of any one of embodiments 1-12; a laser scanner that steers the delayed-output beamlet through an angular range in a plane; and a scanning lens that focuses the steered delayed-output beamlet to a focused spot that traces a raster in an image plane of the scanning lens; the laser scanner being between the polarizing beamsplitter and the scanning lens on the delayed output-beam path.

Embodiment 15. An optical beamlet-array generator includes: a ring resonator including a plurality of mirrors defining a plurality of distinct optical paths within the ring resonator; an input-coupler that directs an incident optical signal to propagate, as a first delayed-beamlet, within the ring resonator along at least part of a first optical path of the plurality of distinct optical paths within the ring resonator; a polarizing beamsplitter that (i) is between a first mirror and a final mirror of the plurality of mirrors, (ii) reflects the transverse electric (TE) polarization component of the first delayed-beamlet as a delayed output beamlet propagating along a delayed output-beam path, (iii) transmits the transverse magnetic (TM) polarization component of the first delayed-beamlet onto a second optical path of the plurality of distinct optical paths as a second delayed-beamlet propagating toward the first mirror and (iv) after the final mirror reflects the second delayed-beamlet, reflects the transverse electric (TE) polarization component of the second delayed-beamlet out of the second optical path as an additional delayed-output beamlet that propagates along an additional delayed output-beam path that is laterally offset from the delayed output-beam path; and a polarization optic, on the second optical path, that modifies the second delayed-beamlet's polarization state.

Embodiment 16. The optical beamlet-array generator of embodiment 15, further includes: an additional polarization optic, on the first optical path, that modifies the first delayed-beamlet's polarization state.

Embodiment 17. An optical beamlet-array generation method includes: splitting an optical signal to yield a (i) first output beamlet having a first polarization state and propagating along a first output-beam path and (ii) a delayed-beamlet having a delayed polarization state, orthogonal to the first polarization state; directing the delayed-beamlet around a ring resonator; and after said directing, splitting the delayed-beamlet to yield a delayed-output beamlet that propagates along a delayed output-beam path that is laterally offset from the first output-beam path.

Embodiment 18. The method of embodiment 17, the delayed-beamlet having a transverse electric (TE) polarization component and a transverse magnetic (TM) polarization component, and splitting the delayed-beamlet includes: reflecting the TE polarization component to yield the delayed-output beamlet; and transmitting the TM polarization component of the delayed-beamlet to yield an additional delayed-beamlet.

Embodiment 19. The method of either one of embodiments 17 and 18, further includes: directing the additional delayed-beamlet around the ring resonator; and after directing the additional delayed-beamlet; and splitting the additional delayed-beamlet to yield an additional delayed-output beamlet that propagates along an additional delayed output-beam path that is laterally offset from both the first output-beam path and the delayed output-beam path.

Embodiment 20. The method of any one of embodiments 17-19, further includes: modifying the intensity of the delayed-output beamlet by, before splitting the delayed-beamlet, changing a polarization of the delayed-beamlet.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments.

Regarding instances of the terms “and/or” and “at least one of,” for example, in the cases of “A and/or B” and “at least one of A and B,” such phrasing encompasses the selection of (i) A only, or (ii) B only, or (iii) both A and B. In the cases of “A, B, and/or C” and “at least one of A, B, and C,” such phrasing encompasses the selection of (i) A only, or (ii) B only, or (iii) C only, or (iv) A and B only, or (v) A and C only, or (vi) B and C only, or (vii) each of A and B and C. This may be extended for as many items as are listed.

The following claims are intended to cover all generic and specific features described herein, as well as all statements of the scope of the present method and system, which, as a matter of language, might be said to fall therebetween

We claim:

1. An optical beamlet-array generator comprising:
a ring resonator including a plurality of mirrors that in part define a plurality of distinct optical paths within the ring resonator;
a polarizing beamsplitter that (i) is between a first mirror and a final mirror of the plurality of mirrors, (ii) outputs a first polarization component of an incident optical signal as a non-delayed output beamlet propagating along a non-delayed output-beam path, (iii) outputs a second polarization component of the incident optical signal onto a first optical path of a plurality of distinct optical paths as a first delayed-beamlet propagating toward the first mirror and (iv) after the final mirror reflects the first delayed-beamlet, reflects the transverse electric (TE) polarization component of the first delayed-beamlet out of the first optical path as a delayed-output beamlet that propagates along a delayed output-beam path that is laterally offset from the non-delayed output-beam path; and
a polarization optic, on the first optical path, that modifies the first delayed-beamlet's polarization state.

2. The optical beamlet-array generator of claim 1,
the polarizing beamsplitter having a beam-splitting surface;
the first polarization component being transverse magnetic (TM) and in a plane perpendicular to the beam-splitting surface, which transmits the first polarization component; and
the second polarization component being TE and parallel to the beam-splitting surface, which reflects the second polarization component.

3. The optical beamlet-array generator of claim 1,
the polarizing beamsplitter having a beam-splitting surface;
the first polarization component being TE and parallel to the beam-splitting surface, which reflects the first polarization component; and
the second polarization component being TM and in a plane perpendicular to the beam-splitting surface, which transmits the second polarization component.

4. The optical beamlet-array generator of claim 3, further comprising:
an input-coupler that directs the incident optical signal to propagate within the ring resonator along an incident optical path toward the polarizing beamsplitter.

5. The optical beamlet-array generator of claim 1, the second polarization component being the TM polarization component, and further comprising:
an additional polarization optic on a second optical path of the plurality of distinct paths, wherein:
the polarizing beamsplitter (v) transmits the TM polarization component of the first delayed-beamlet, transmitted by the polarization optic, onto the second optical path as a second delayed-beamlet propagating toward the first mirror and (vi) reflects the TE polarization component of the second delayed-beamlet, transmitted by the additional polarization optic, out of the second optical path as an additional delayed-output beamlet that propagates along an additional delayed output-beam path that is laterally offset from both the non-delayed output-beam path and the delayed output-beam path.

6. The optical beamlet-array generator of claim 1,
the plurality of mirrors further including a second mirror and a third mirror, wherein the second mirror reflects the first delayed-beamlet to the third mirror, which reflects the first delayed-beamlet to the final mirror, which reflects the first delayed-beamlet to the polarizing beamsplitter; and
each of the plurality of distinct optical paths defining a respective quadrilateral, vertices of which are on respective reflective surfaces of the first mirror, the second mirror, the third mirror, and the final mirror.

7. The optical beamlet-array generator of claim 6, the first mirror and the third mirror having, respectively, a first reflective surface and a third reflective surface,
a beam-splitting surface of the polarizing beamsplitter being parallel to at least one of the first reflective surface and the third reflective surface.

8. The optical beamlet-array generator of claim 6, the second mirror and the final mirror having, respectively, a second reflective surface and a final reflective surface,
a beam-splitting surface of the polarizing beamsplitter being perpendicular to at least one of the second reflective surface and the final reflective surface.

9. The optical beamlet-array generator of claim 6,
the ring resonator being unstable, at least one of the plurality of mirrors having an angular orientation that deviates from an angular orientation required for the ring resonator to be stable, and
each of the respective quadrilaterals being a non-rectangular quadrilateral.

10. The optical beamlet-array generator of claim 9, the first mirror, the second mirror, the third mirror, and the final mirror having, respectively, a first reflective surface, a second reflective surface, a third reflective surface, and a final reflective surface, and at least one of:
the first reflective surface and the third reflective surface being nonparallel; and
the second reflective surface and the final reflective surface being nonparallel.

11. The optical beamlet-array generator of claim 7, the ring resonator being unstable by virtue of at least one of:
a distance between the first mirror and the final mirror differing from a distance between the second mirror and the third mirror; and
a distance between the first mirror and the second mirror differing from a distance between the third mirror and the final mirror.

12. The optical beamlet-array generator of claim 1,
the plurality of mirrors further comprising a second mirror, wherein the second mirror reflects the first delayed-beamlet to the final mirror, which reflects the first delayed-beamlet to the polarizing beamsplitter, and
each of the plurality of distinct optical paths defining a respective triangle, vertices of which are on respective reflective surfaces of the first mirror, the second mirror, and the final mirror.

13. A cascaded optical beamlet-array generator comprising:
a first optical beamlet generator of claim 1, where (i) the delayed output-beam path is laterally offset from the non-delayed output-beam path in a first direction, and (ii) the non-delayed output beamlet and the delayed-output beamlet form a multi-spot optical signal; and
a second optical beamlet generator of claim 1 that receives, as its incident optical signal, the multi-spot optical signal, and outputs, as its output beamlets, a third output beamlet and a fourth output beamlet that is laterally offset from the third output beamlet in a second direction that is perpendicular to the first direction.

14. A microscope comprising:
an optical beamlet generator of claim 1;
a laser scanner that steers the delayed-output beamlet through an angular range in a plane; and
a scanning lens that focuses the steered delayed-output beamlet to a focused spot that traces a raster in an image plane of the scanning lens;
the laser scanner being between the polarizing beamsplitter and the scanning lens on the delayed output-beam path.

15. An optical beamlet-array generator comprising:
a ring resonator including a plurality of mirrors defining a plurality of distinct optical paths within the ring resonator;
an input-coupler that directs an incident optical signal to propagate, as a first delayed-beamlet, within the ring resonator along at least part of a first optical path of the plurality of distinct optical paths within the ring resonator;
a polarizing beamsplitter that (i) is between a first mirror and a final mirror of the plurality of mirrors, (ii) reflects the transverse electric (TE) polarization component of the first delayed-beamlet as a delayed output beamlet propagating along a delayed output-beam path, (iii) transmits the transverse magnetic (TM) polarization component of the first delayed-beamlet onto a second optical path of the plurality of distinct optical paths as a second delayed-beamlet propagating toward the first mirror and (iv) after the final mirror reflects the second delayed-beamlet, reflects the transverse electric (TE) polarization component of the second delayed-beamlet out of the second optical path as an additional delayed-output beamlet that propagates along an additional delayed output-beam path that is laterally offset from the delayed output-beam path; and
a polarization optic, on the second optical path, that modifies the second delayed-beamlet's polarization state.

16. The optical beamlet-array generator of claim 15, further comprising:
an additional polarization optic, on the first optical path, that modifies the first delayed-beamlet's polarization state.

17. An optical beamlet-array generation method comprising:
splitting an optical signal to yield a (i) first output beamlet having a first polarization state and propagating along a first output-beam path and (ii) a delayed-beamlet having a delayed polarization state, orthogonal to the first polarization state;
directing the delayed-beamlet around a ring resonator; and after said directing,
splitting the delayed-beamlet to yield a delayed-output beamlet that propagates along a delayed output-beam path that is laterally offset from the first output-beam path.

18. The method of claim 17, the delayed-beamlet having a transverse electric (TE) polarization component and a transverse magnetic (TM) polarization component, and splitting the delayed-beamlet comprising:
reflecting the TE polarization component to yield the delayed-output beamlet; and
transmitting the TM polarization component of the delayed-beamlet to yield an additional delayed-beamlet.

19. The method of claim 18, further comprising:
directing the additional delayed-beamlet around the ring resonator; and after directing the additional delayed-beamlet; and
splitting the additional delayed-beamlet to yield an additional delayed-output beamlet that propagates along an additional delayed output-beam path that is laterally offset from both the first output-beam path and the delayed output-beam path.

20. The method of claim 17, further comprising: modifying the intensity of the delayed-output beamlet by, before splitting the delayed-beamlet, changing a polarization of the delayed-beamlet.
